(19) United States
(12) Patent Application Publication
(10) Pub. No.: US 2020/0389821 A1
(43) Pub. Date: Dec. 10, 2020

(54) CHANNEL RESERVATION FOR MULTIPLE WIRELESS DEVICES

(71) Applicant: Telefonaktiebolaget LM Ericsson (publ), Stockholm (SE)

(72) Inventors: Gen Li, Beijing (CN); Reem Karaki, Aachen (DE); Peter Alriksson, Hörby (SE); Tai Do, Lund (SE)

(21) Appl. No.: 16/959,576

(22) PCT Filed: Jan. 18, 2019
(86) PCT No.: PCT/SE2019/050034

§ 371 Date: Jul. 1, 2020

Related U.S. Application Data
(60) Provisional application No. 62/619,139, filed on Jan. 19, 2018.

(51) Int. Cl. H04W 28/26; H04W 72/04; H04W 24/08; H04B 7/06; H04L 5/00

(52) U.S. Cl. CPC H04W 28/26; H04W 72/0453; H04L 5/0051; H04B 7/0626; H04W 24/08

(57) ABSTRACT

A network node of a wireless communication network transmits a channel reservation request message for receipt by multiple wireless devices and monitors for response to the channel reservation request message. The channel reservation request message comprises information based upon which at least two wireless devices can be identified, and information defining one or more transmission opportunities for the at least two wireless devices. The transmission opportunities are reserved for transmitting responses to the channel reservation request message to the network node. Monitoring for response to the channel reservation request message involves checking for responses from the at least two wireless devices.

### TECHNICAL FIELD

Embodiments herein relate to wireless communication and more specifically to channel reservation in a wireless communication network.

### BACKGROUND

Mobile broadband will continue to drive the demands for higher overall traffic capacity and higher achievable end-user data rates in wireless communication networks. Several scenarios in the future will require data rates of up to 10 Gbps in local areas. These demands for very high system capacity and very high end-user date rates can be met by networks with distances between access nodes ranging from a few meters in indoor deployments up to roughly 50 m in outdoor deployments, i.e. with an infra-structure density considerably higher than the most dense networks of today. The wide transmission bandwidths needed to provide data rates up to 10 Gbps and above can likely only be obtained from new technologies. High-gain beamforming with massive number of antennas, typically realized with array antennas, can be used to increase the system throughput while mitigating interference. We refer to such networks as New Radio (NR) systems in the following.

Besides traditional licensed exclusive bands, NR systems are also expected to be operating on unlicensed bands especially for enterprise solutions. Thus coexistence support is needed to enable spectrum sharing between different operators or other systems. The Listen-Before-Talk (LBT) mechanism is the most flexible way to achieve this. The most important reason is that it is a distributed mechanism so that there are no needs to exchange information between different systems which may be more difficult. Besides, signaling based channel reservation such as Request To Send/Clear To Send (RTS/CTS) handshaking is proposed to solve the so-called hidden node problem.

Listen before talk is employed by widely used WiFi systems. Wi-Fi is a popular technology that allows an electronic device to exchange data wirelessly over a computer network, including high-speed Internet connections. Wi-Fi systems are the Wireless Local Area Network (WLAN) products that are based on Institute of Electrical and Electronics Engineers (IEEE) 802.11 standards.

As shown in FIG. 1, the basic IEEE 802.11 Media Access Control (MAC) protocol employs a Carrier Sense Multiple Access with Collision Avoidance (CSMA/CA)-based MAC. The same protocol is applied by all stations, including the access point, i.e. in both downlink (DL) and uplink (UL). A station that wishes to transmit a packet first senses the medium. If the medium is sensed idle for a certain minimum time, a so-called Distributed Inter Frame Space (DIFS), the packet is transmitted. If the medium is busy, the station first defers until the medium is sensed idle. When this occurs, the station does not transmit immediately, which would lead to collisions if more than one station was deferring. Instead, the station sets a backoff timer to a random number, and does not transmit until this timer has expired. The backoff timer is only decreased when the medium is sensed idle, whereas whenever the medium is sensed busy, a deferral state is entered where the backoff timer is not decreased. When the backoff timer expires, the packet is transmitted. If the packet is successfully received, the receiver responds with an acknowledgement (ACK) to the transmitter. The acknowledgement is sent a Short Inter Frame Space (SIFS) after the data frame is received. Since SIFS<DIFS, no other user will access the medium during this time. If no acknowledgement is received, either because the packet itself or the acknowledgement was lost, the transmitter generates a new backoff, and retransmits the packet when the backoff timer has expired. Even if the packet was successfully acknowledged, the transmitter must generate a backoff and wait for it to expire before transmitting the next packet. To avoid congestion, when collisions occur, backoff values are drawn from distributions with larger and larger expectations for every retransmission attempt.

The RTS/CTS access method is an additional four-way handshaking technique and very effective in solving the so-called hidden terminal problem. The RTS/CTS mechanism is shown in FIG. 2. When the sender wants to transmit a packet, it sends a short frame called Request To Send (RTS) instead of the packet first after the channel has been sensed idle for a DIFS. When the receiver detects the RTS, it responses, after a SIFS, with a clear to send (CTS) frame. A successful RTS/CTS exchange reserves the channel for the sender-receiver pair. Other stations adjust their Network Allocation Vectors (NAVs) based on the duration field of the RTS or of the CTS. The sender starts to transmit the packet after a SIFS only if it received the CTS frame correctly. Same as in the basic access method, the receiver will send back an ACK to acknowledge after received the packet successfully. If the CTS is not received within a given time frame, the sender retransmits the RTS according to the backoff rules similar to the basic access method.

There have been discussions to adopt a similar RTS/CTS mechanism as mentioned in the Background to NR Unlicensed operation (NR-U), especially in high frequency band, where the so-called hidden node problem becomes more severe due to high pathloss.

FIG. 3 illustrates an example of a similar RTS/CTS mechanism similar as discussed in the Background but for NR-U. In the preparation stage before the data transmission stage, a radio base station, often referred to as gNB in the context of NR, first sends a Channel Reservation ReQuest (CRRQ) to one UE that responds with a Channel Reservation ReSponse (CRRS). In both the above messages, a reservation period value is indicated to let others know that this link already reserves the channel. The transmission of the messages would be subject to successful LBT as also indicated in the figure. The preparation stage is followed by a data transmission stage comprising several consecutive Transmission time Intervals (TTIs) with DI and UL transmissions that involves Physical Downlink Control CHannel (PDCCH), Physical Downlink Shared CHannel (PDSCH), Physical Uplink Shared CHannel (PUSCH), Physical Uplink Control CHannel (PUCCH) and DeModulation Reference Signals (DMRS) for these channels. DMRS presence may be implied when these channels are mentioned.

Conventionally, e.g. in WiFi, RTS/CTS is designed for data exchange, DL and/or UL, of one link only. For example, RTS message is only targeting to one receiver which will response with one CTS only. This is also what has been discussed for channel reservation in NR-U.

### SUMMARY

In view of the above, an object of the present disclosure is to overcome or at least mitigate at least some of the drawbacks related to the prior art, such as to provide improvements for wireless communication networks and systems with increased demands on supporting an increased number of users, shared spectrum, higher throughput, lower latency etc, as for example us expected for NR systems.

According to a first aspect of embodiments herein, the object is achieved by a a method performed by a network node of a wireless communication network. The network node transmits a channel reservation request message and monitors for response to the channel reservation request message. The channel reservation request message comprises information based upon which at least two wireless devices can be identified and information defining one or more transmission opportunities for the at least two wireless devices. Said one or more transmission opportunities are reserved for transmitting responses to the channel reservation request message to the network node. Monitoring for response to the channel reservation request message involves checking for said responses from the at least two wireless devices.

According to a second aspect of embodiments herein, the object is achieved by a a network node configured to be a network node of a wireless communication network. The network node comprises processing circuitry and a radio interface configured to transmit a channel reservation request message from the network node, and monitor for a response to the channel reservation request message. The channel reservation request message comprises information based upon which at least two wireless devices can be identified and information defining one or more transmission opportunities for the at least two wireless devices. The one or more transmission opportunities are reserved for transmitting responses to the channel reservation request message to the network node. To monitor for response to the channel reservation request message involves checking for said responses from the at least two wireless devices.

According to a third aspect of embodiments herein, the object is achieved by a computer program comprising computer code which, when run on a processing circuitry of a network node causes the network node to transmit a channel reservation request message from the network node and monitor for a response to the channel reservation request message. The channel reservation request message comprises information based upon which at least two wireless devices can be identified and information defining one or more transmission opportunities for the at least two wireless devices. The one or more transmission opportunities are reserved for transmitting responses to the channel reservation request message to the network node. To monitor for response to the channel reservation request message involves checking for said responses from the at least two wireless devices.

According to a fourth aspect of embodiments herein, the object is achieved by a computer program product comprising a computer-readable storage medium storing the computer program according to the third aspect.

According to a fifth aspect of embodiments herein, the object is achieved by a method performed by a wireless device in a wireless communication network. the wireless device monitors for a channel reservation request message from a network node of the wireless communication network. If a channel reservation request message containing an identification of the wireless device is received, the wireless device sends a response to the channel reservation request message to the network node. The channel reservation request message comprises information based upon which at least two wireless devices can be identified and information defining one or more transmission opportunities for the at least two wireless devices, which transmission opportunities are reserved for transmitting responses to the channel reservation request message to the network node.

According to a sixth aspect of embodiments herein, the object is achieved by a wireless device for communication in a wireless communication network. The wireless device comprises a processing circuitry and a radio interface configured to monitor for a channel reservation request message from a network node of the wireless communication network and if a channel reservation request message containing an identification of the wireless device is received, send a response to the channel reservation request message to the network node. The channel reservation request message comprises information based upon which at least two wireless devices can be identified and information defining one or more transmission opportunities for the at least two wireless devices, which one or more transmission opportunities are reserved for transmitting responses to the channel reservation request message to the network node.

According to a seventh aspect of embodiments herein, the object is achieved by a computer program comprising computer code which, when run on a processing circuitry of a wireless device, causes the wireless device to monitor for a channel reservation request message from a network node of a wireless communication network, and if a channel reservation request message containing an identification of the wireless device is received, send a response to the channel reservation request message to the network node. The channel reservation request message comprises information based upon which at least two wireless devices can be identified and information defining one or more transmission opportunities for the at least two wireless devices, which one or more transmission opportunities are reserved for transmitting responses to the channel reservation request message to the network node.

According to an eight aspect of embodiments herein, the object is achieved by a computer program product comprising a computer-readable storage medium storing the computer program according to the seventh aspect.

Thanks to embodiments herein where the network node, e.g. gNB, may send a channel reservation request to multiple wireless devices, whose channel reservation responses then can be transmitted simultaneously, e.g. with an interlace multiplexing design, the network node can schedule data transmission for multiple users within one Transmission OPportunity (TXOP) e.g. using a signaling based channel reservation framework. By enabling multiple wireless devices to share a TXOP, embodiments described herein are beneficial in terms of resource utilization, scheduling flexibility, and enables small latency.

Embodiments herein thus result in an improvement for wireless communication networks and systems with increased demands on e.g. supporting an increased number of users, shared spectrum, higher throughput, lower latency etc.

### BRIEF DESCRIPTION OF THE DRAWINGS

Examples of embodiments herein are described in more detail with reference to the appended schematic drawings, which are briefly described in the following.

FIG. 1 schematically illustrates a prior art protocol.

FIG. 2 schematically illustrates a prior art handshaking mechanism.

FIG. 3 schematically illustrates another handshaking mechanism.

FIG. 4 schematically illustrates a wireless communication network.

FIG. 5 schematically illustrates a channel reservation request

FIG. 6 schematically illustrates a first example of transmission opportunity.

FIG. 7 schematically illustrates second example of transmission opportunities.

FIG. 8 schematically illustrates a third example of transmission opportunities.

FIG. 9 schematically illustrates a channel reservation response.

FIG. 10 is a flowchart schematically illustrating a first method.

FIG. 11 is a flowchart schematically illustrating a second method.

FIG. 12 schematically illustrates signaling between nodes.

FIG. 13 is a block diagram schematically illustrating a network node.

FIG. 14 is a block diagram schematically illustrating a wireless device.

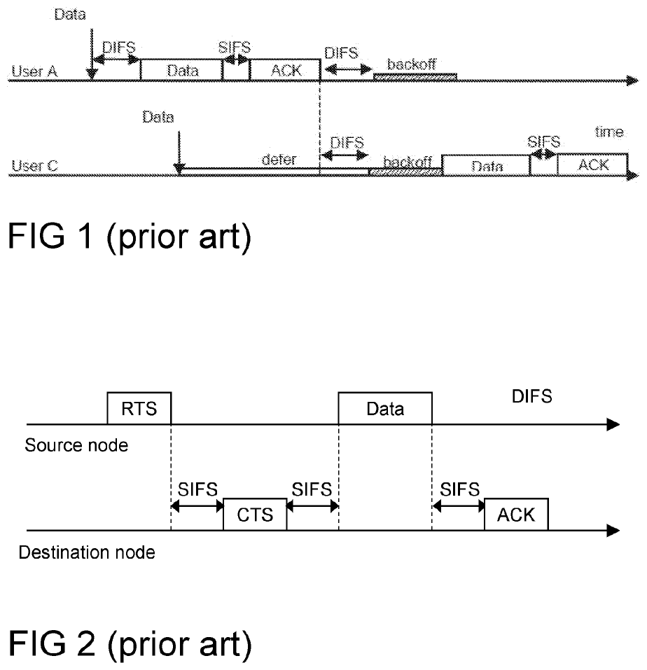

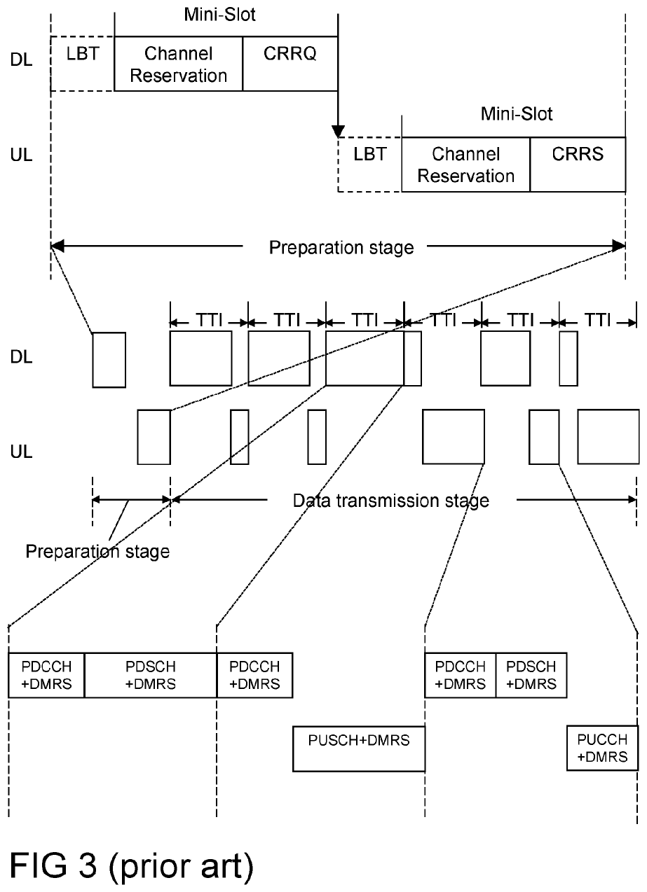

### DETAILED DESCRIPTION

Although terminology from Third Generation Partnership Project (3GPP) Long Term Evolution (LTE) and NR are used in this disclosure to exemplify various embodiments, this should not be seen as limiting the scope of the present disclosure to only the aforementioned system. Other wireless systems may also benefit from exploiting the ideas covered within this disclosure.

Also, terminologies as used herein such as gNB, which typically is used to refer to a NodeB, i.e. a radio base station. in the context of NR, and User Equipment (UE) should be considered non-limiting and does in particular not imply a certain hierarchical relation between the two; Generally, “gNB” may be considered as a first device and “UE” may be considered as another, second device and these two devices are arranged to communicate with each other over some radio channel, i.e. wirelessly. Similarly, “gNB” may be considered as a first node and a “UE” may be considered a second or further node. Moreover, a gNB may be named Base Station (BS) or network node in the present disclosure.

Furthermore, the expression “UE” is used herein to denote wireless communication devices such as mobile phones, smartphones as well as machine-type communication (MTC) devices and so-called Internet of Things (IoT) communication devices. A UE may thus herein be named a wireless communication device or simply wireless device.

In the following, embodiments herein are illustrated by exemplary embodiments. It should be noted that these embodiments are not necessarily mutually exclusive. Components from one embodiment may be tacitly assumed to be present in another embodiment and it will be obvious to a person skilled in the art how those components may be used in the other exemplary embodiments.

In short, embodiments that will be described in further detail below, involve multiple channel reservation responses instead of one. Embodiments herein involve a first node, e.g. a radio base station, sending a channel reservation request to multiple other nodes, e.g. wireless devices, whose channel reservation response(s) may be transmitted in the same Transmission OPportunity (TXOP) and/or transmitted simultaneously, e.g. by using interlace multiplexing. For example, a gNB may send a channel reservation request to multiple UEs whose channel reservation responses are transmitted simultaneously with an interlace multiplexing design. This enables the gNB to schedule data transmission for multiple users within one Transmission OPportunity (TXOP) using a signaling based channel reservation framework. By allowing multiple UEs to share a TXOP, embodiments described herein may be beneficial in terms of resource utilization, scheduling flexibility, and small latency, which is desirable for meeting present and increased demands on wireless communication networks as mentioned above.

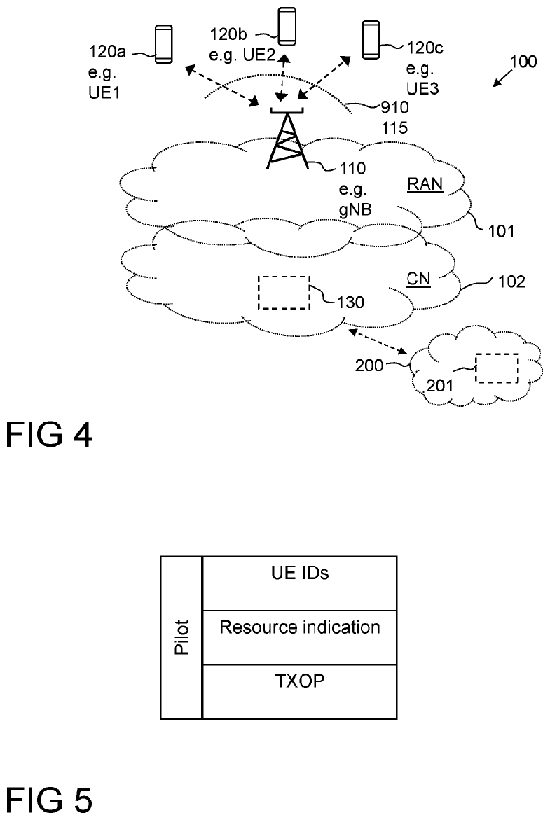

FIG. 4 is a block diagram schematically depicting a wireless communication network 100, i.e. a communication system, e.g. a NR system, that will be used for exemplifying embodiments herein, and in which embodiments herein may be implemented. The wireless communication network comprises a network node 110 or first node, which may correspond to a base station, BS, or gNB, and is shown in a situation where it is communicatively connected, and e.g. communicates, with further nodes, typically one or more wireless devices, such as wireless devices 120a-c, as exemplified in the figure. The wireless devices 120a-c may correspond to a first UE, denoted UE1, a second UE, denoted UE2, and a third UE, denoted UE3, as described and used in examples herein. The network node 110 may communicate with the wireless devices 120a-c as described herein via a wireless air interface 115. The network node 110 may be connected to one or more further nodes 130 of the wireless communication network 100, e.g. nodes in a Radio Access Network (RAN) 101 and/or nodes in a Core Network (CN) 102 and/or also one or more virtualized nodes in a virtualized infrastructure, i.e. a so-called cloud or computer cloud. Such cloud may correspond to or be part of a further network 200 that may be located outside the wireless communication network 100, i.e. be an external network 201, as indicated in the figure. The further network may be formed by one or more further nodes 201. The cloud may provide and/or implement services and/or functions for and/or relating to the wireless communication network 100.

FIG. 5 schematically illustrates a CRRQ. In some embodiments a gNB, e.g. the network node 110, broadcasts CRRQ to multiple UEs, e.g. wireless devices 110a-c, for which it wishes to schedule the data transmission in a following transmission opportunity, i.e. TXOP. In more detail, the shown CRRQ includes a pilot and payload. The pilot may be a common preamble for each node's fast detection. For example, it may reuse a Primary Synchronization Signal (PSS) similar sequence. Besides a reservation TXOP value as shown in the figure, the payload may include multiple UE IDs, i.e. identifiers identifying multiple wireless devices, the gNB intends to schedule data transmission for and allocated resource location, named resource indication in the figure, for CRRS of each UE. The resource indication may thus comprise information indicating transmission resources for the CRRSs, i.e. responses to the CRRQ. For example, CRRS from multiple UEs may be multiplexed using different interlaces in the UL transmission. In this case, allocated interlace(s), e.g. by interlace number(s), for each UE's CRRS transmission may be implicitly or explicitly indicated in the payload, i.e. payload of the CRRQ. Optionally the CRRQ may also include Channel State Information (CSI) Reference Signal (RS) transmission and CSI report requests for the multiple UEs.

In some embodiments, when nodes, e.g. UEs, detect the pilot for CRRQ, they start to decode the payload and check if their respective ID is included in the UE IDs. If the ID is included in UE ID list of CRRQ, the UE will further determine which resource to transmit CRRS. The resource number may be explicitly included in the resource indication field, or implicitly included in the order number of UE ID list. For example, when the UE ID is decoded as the second one, the UE may use interlace #2, i.e. a second interlace or interlace number 2, for CRRS transmission. If its ID is not included in UE ID list of CRRQ, the UE may further decode the TXOP field and defer the transmission until end of the TXOP.

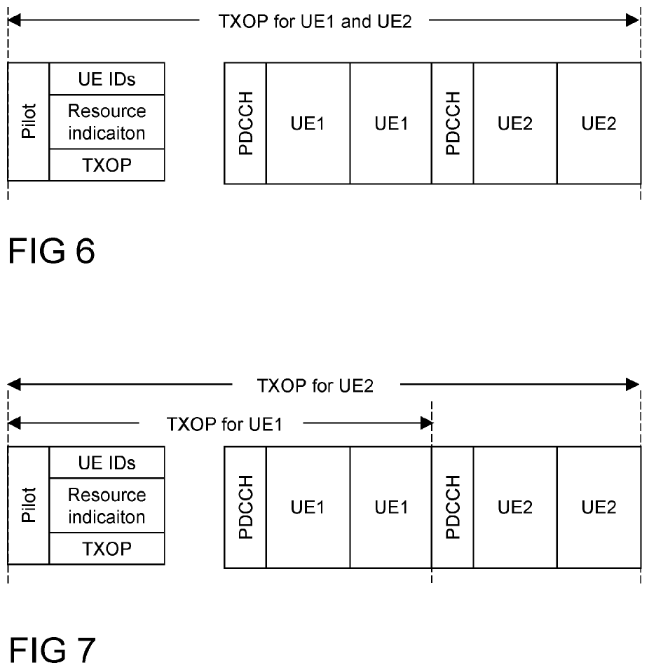

FIGS. 6 and 7 schematically illustrates a examples of transmission opportunities, i.e. TXOPs. In various embodiments, the TXOP field may be one of the following two alternatives:
One common value to reserve the channel for data transmission between gNB, e.g. the network node 110, and requested UEs, e.g. wireless devices 120a-c, that responds to the CRRQ. This is exemplified in FIG. 6.
UE-specific TXOP value for different UEs. This may apply to a case where the gNB pre-schedules data for different UEs when CRRQ is generated. Since different UEs may be Time Division Multiplexed (TDM) with different ending points, the TXOP for different UEs are different. This is exemplified in FIG. 7.

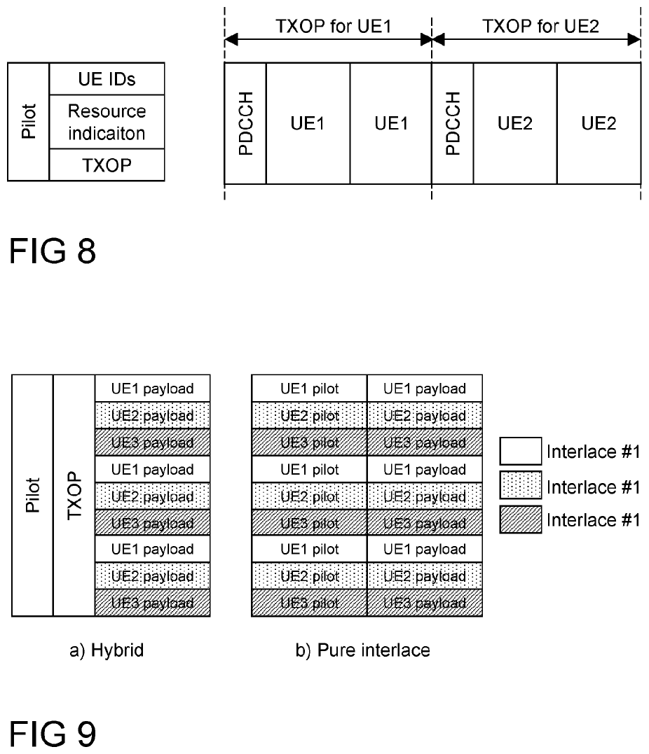

FIG. 8 schematically illustrates another example of transmission opportunity, i.e. TXOP. As exemplified, in some embodiments, the TXOP may be a specific time interval.

In some embodiments, the transmission time of CRRQ, e.g. by the network node 110, is located in a region the UEs, e.g. the wireless devices 120a-c, are monitoring the channel. This region may be configured to the UEs via Radio Resource Control (RRC) signaling in advance, e.g. when the connection is set up.

In some embodiments, the CRRQ may be combined with another signal recognized by other technologies in the same channel. For example, one CTS-to-self packet in WiFi may be put at the head of CRRQ in order to reserve the channel from Wi-Fi.

In some embodiments, the part of the CRRQ after the pilot has the same structure as the Physical Downlink Control Channel (PDCCH), e.g. NR PDCCH.

In some embodiments, the UEs whose IDs are included in CRRQ will transmit CRRS to the requesting gNB when a short LBT is successful. Otherwise they will not respond with the CRRS.

FIG. 9 schematically illustrates a channel reservation response, i.e. CRRS. In some embodiments, the CRRS includes pilot, TXOP reservation value and UE-specific payload.

A first option of CRRS transmission is a) Hybrid interlaced transmission. The pilot and TXOP reservation value are the same for each UE, e.g. each of wireless devices 120a-c, which cover the whole carrier without interlacing. The UE-specific payload such as whether it may be transmitted or not, e.g. determined by 1 bit, CSI report and etc. are transmitted with different interlaces as were indicated in the CRRQ. The common transmission may then be transmitted in a Single Frequency Network (SFN) way. This allows the UE to use its maximum output power so that its transmission will cover an area corresponding to a full allocation. The interlaced part will typically need to have pilots for each UE. Because the UE payload is intended for the serving gNB, more than one UE can be multiplexed on the same interlace using for example Orthogonal Cover Code (OCC).

A second option of CRRS transmission is b) Pure interlaced transmission. The whole part of CRRS is here interlaced by multiple UEs, e.g. the wireless devices 120a-c, for pilot and payload. Different UEs may share the same pilot but transmitted in different interlaces.

In some embodiments, the gNB, e.g. the network node 110, that is sending CRRQ and expecting CRRS tries to detect the pilot to identify the existence of CRRS from UEs, e.g. the wireless devices 120a-c. For a) the hybrid solution, it may make a correlation in the whole carrier to see whether the CRRS pilot is existing and then decode interlaced payload for each UE. For b) the pure interlaced solution, it may make correlation for each interlace to see whether the requesting UE's CRRS pilot exists. If it exists, the gNB may continue to decode the payload for that UE.

In some embodiments, other nodes, e.g. another network node than the network node 110, may try to detect the pilot to identify the existence of CRRS. For a) the hybrid solution, it may make correlation in the whole carrier to see whether the CRRS pilot is existing. If it is existing, the TXOP value may be decoded and transmission deferred until end of the TXOP. For b) the pure interlaced solution, it may check the pilot in each interlace. When the pilot from one interlace is detected, it may continue to decode the payload in the interlace to find the TXOP value. Then the node may defer transmission until the end of TXOP.

In some embodiments, for example corresponding to at least some embodiments described above, the TXOP value in the CRRS should be aligned with the TXOP value in the CRRQ. When a common TXOP is used in the CRRQ, the common TXOP indicating the end of transmission should be included in the CRRS. Typically, TXOP in CRRS should equal TXOP in CRRQ minus interval between start of CRRS and CRRQ.

In some embodiments, when a UE specific TXOP is used in the CRRQ, each UE should generate its own TXOP and put it in the CRRS.

In some embodiments, the CRRS may be combined with another signal recognized by other technology in the same channel. For example, one CTS-to-self packet in WiFi may be put at the head of CRRQ in order to reserve the channel from Wi-Fi.

In some embodiments, the interlaced part of the CRRS after the pilot has the same structure as the short Physical Uplink Control CHannel (sPUCCH), e.g. NR sPUCCH.

Regarding data transmission, in some embodiments, a gNB, e.g. the network node 110, may schedule the data transmission for the UEs, e.g. some of the wireless devices 120a-c, whose CRRS is decoded and admit transmission. For example, the network node 110, e.g., gNB may send CRRQ to wireless devices 120a-c, e.g. UE1, UE2 and UE3, but only wireless devices 110a-b, e.g. UE1 and UE2, respond with CRRS. Then the network node 110 may only schedule the DL and UL transmission for these devices.

When some UEs, i.e. wireless devices, are not responding, e.g. wireless device 110c, is not responding, the gNB, e.g. network node 110 may check the buffer status of UEs who may transmit and re-schedule the resource according to the reserved situation.

If the buffer of UEs who allowed transmission may cover the whole TXOP and the channel is reserved by these UEs, the gNB may just schedule the data for the allowable UEs. For example, in FIG. 6, if UE1 failed to respond with CRRS, the pre-scheduled resource for UE1 may be re-scheduled to UE2's buffered data. However, in the example of FIG. 7, such re-scheduling cannot be done because the UE1's resource is not reserved by UE2.

Otherwise the gNB may use more resources for allowable UEs than what was planned during scheduling step by e.g. reducing the coding rate and increase the robustness of the transmissions.

In some embodiments, the gNB may also schedule UE to UE transmission, i.e. transmission between UEs. For example, a gNB, e.g. the network node 110, may send CRRQ to UE1, UE2, e.g. wireless devices 110a-b, and both of them respond with CRRS. Then the gNB may also schedule transmission between UE1 and UE2.

In some embodiments, the gNB, e.g. the network node 110, will send the CRRQ again if none of the requested UEs, e.g. wireless devise 110a-b, responds.

In some embodiments, data transmissions for different UEs, e.g. for wireless devices 110a-c, may be multiplexed within a TXOP in frequency by Orthogonal Frequency-division Multiple Access (OFDMA) per interlace, or in time where UEs may share different slots in TXOP. For instance, at the beginning of the TXOP, e.g. right after CRRQ, the UEs, e.g. the wireless devices 110a-c, may send their CRRSs simultaneously using OFDMA per interlace. In the remaining of TXOP, UEs can be multiplexed in frequency, in time, or in both.

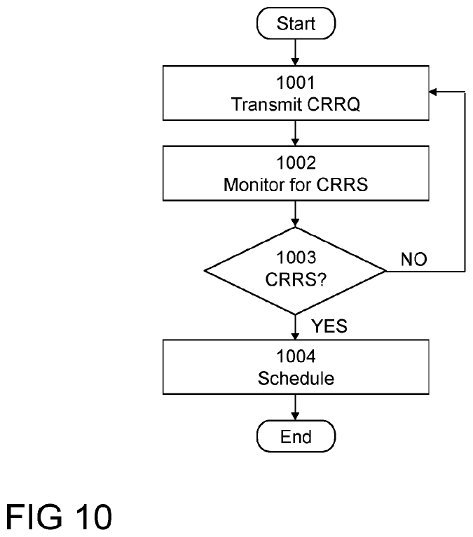

FIG. 10 is a flowchart schematically illustrating embodiments of a first method according to embodiments herein. The first method is implemented in, i.e. performed by, a first node, e.g. the network node 110, such as a base station or gNB, i.e. the network node 110 may perform one or more of the following actions. The first method may thus comprise the following actions, which actions may be taken in any suitable order and/or be carried out fully or partly overlapping in time when this is possible and suitable.

Action 1001

The network node 110 transmits, e.g. sends, a channel reservation request message, e.g. a CRRQ message that may be as described above. The CRRQ message may be transmitted to multiple wireless devices or UEs, such as to the wireless devices 110a-c.

The channel reservation request, or CRRQ, message preferably comprises:
Information, e.g. UE IDs or in general identifiers identifying wireless devices, based upon which at least two wireless devices, e.g. two or more of the wireless devices 120a-c, can be identified.
Information defining one or more transmission opportunities, e.g. TXOP, for said at least two wireless devices, which one or more transmission opportunities are reserved for transmitting responses, e.g. CRRS, to the channel reservation request, e.g. CRRQ, message to the network node 110.

Note that, and as realized by the skilled person, said one or more transmission opportunities are typically not exclusively, i.e. not only, reserved for the responses. The transmission opportunity/ies is typically reserved also for other transmission to/from the wireless devices, such as for data in the DL and/or UL. This is exemplified separately herein.

In some embodiments, the channel reservation request, or CRRQ, message further comprises a pilot.

In some embodiments, the channel reservation request, or CRRQ, message further comprises a channel state information reference signal, e.g. CSI-RS.

In some embodiments, the channel reservation request, or CRRQ, message further comprises channel state information, e.g. CSI, report requests for said at least two wireless devices.

In some embodiments, the channel reservation request, or CRRQ, message further comprises a definition, e.g. TXOP, of a time frame within which said transmission opportunities are reserved for said at least two wireless devices.

In some embodiments, the channel reservation request message further comprises information indicating transmission resources for the responses and that are reserved in a temporally overlapping manner. The transmission resources may thus be overlapping in time. In these embodiments, the channel reservation request, or CRRQ, message may comprise information, e.g. corresponding to the resource indications discussed above, specifying the temporally overlapping manner in which the transmission resources are reserved via instructions to the at least two wireless devices to transmit said responses, e.g. CRRS, in a multiplexed manner, such as by means of interlaces. In this manner, a first wireless device, e.g. the wireless device 120a or UE1, of the at least two wireless devices may be assigned a first interlace for its response, e.g. corresponding to an interlace number, e.g. Interlace #1, which may be information signaled in a payload field of the CRRQ such as a field corresponding to UE IDs (the order of occurrence may determine the interlaces) or the resource indication, as discussed above. Correspondingly, a second wireless device, e.g. the wireless device 120b or UE2, of the at least two wireless devices may be assigned a second interlace for its response, e.g. corresponding to another interlace number, e.g. Interlace #2, in the payload field.

In some embodiments, the channel reservation request message further comprises information indicating transmission resources for the responses and that are reserved in a time-division-multiplexed manner such that a first wireless device, e.g. the wireless device 120a or UE1, of the at least two wireless devices is assigned a first transmission resource, e.g. in a channel, and a second wireless device, e.g. the wireless device 120a or UE2, of the at least two wireless devices is assigned a second transmission resource, e.g. in said channel, which second transmission resource is subsequent to the first transmission resource, i.e. these transmission resources are not temporally overlapping.

Action 1002

The network node 110 monitors for response to the channel reservation request message, e.g. monitors for channel reservation response(s) or CRRS(s) as described above, from multiple wireless devices or UEs, such as from the the wireless devices 110a-c.

The monitoring of the response to the channel reservation request message preferably involves checking for responses from at least two wireless devices, e.g. at least from two of the wireless devices 120a-c.

Action 1003

The network node 110 may check whether at least one response or CRRS has been detected in action 1102. If no such detection has been made, the method may return to action 1101. If the check finds that at least one response or CRRS has been detected, then the network node 110 may continue with Action 1004 below.

Action 1004

The network node 110 may perform scheduling, for example the network node 110 may schedule the DL, UL and/or device-to-device (D2D) transmission for the UE's whose response, e.g. CRRS, has been decoded with admission. The network node 110 preferably schedules, for each of the at least two wireless devices from which response(s), e.g. CRRS, have been received, at least one of:

a channel for transmitting data from the network node 110 to the wireless device, e.g. any one of the wireless devices 120a-c, i.e. schedules in the DL,

a channel for transmitting data from the wireless device, e.g. any one of the wireless devices 120a-c, to the network node 110, i.e. schedule in the UL, and

a channel for transmitting data from a first to a second wireless device of the at least two wireless devices, e.g. from the wireless device 120a to the wireless devices 120b, i.e. schedules D2D.

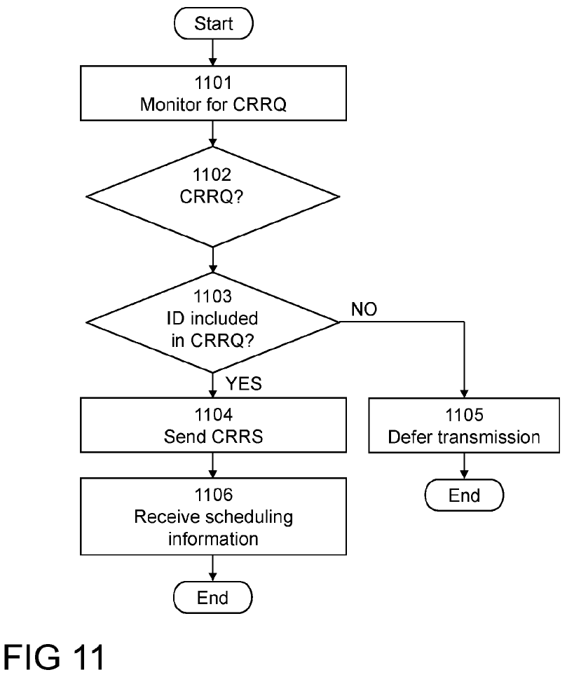

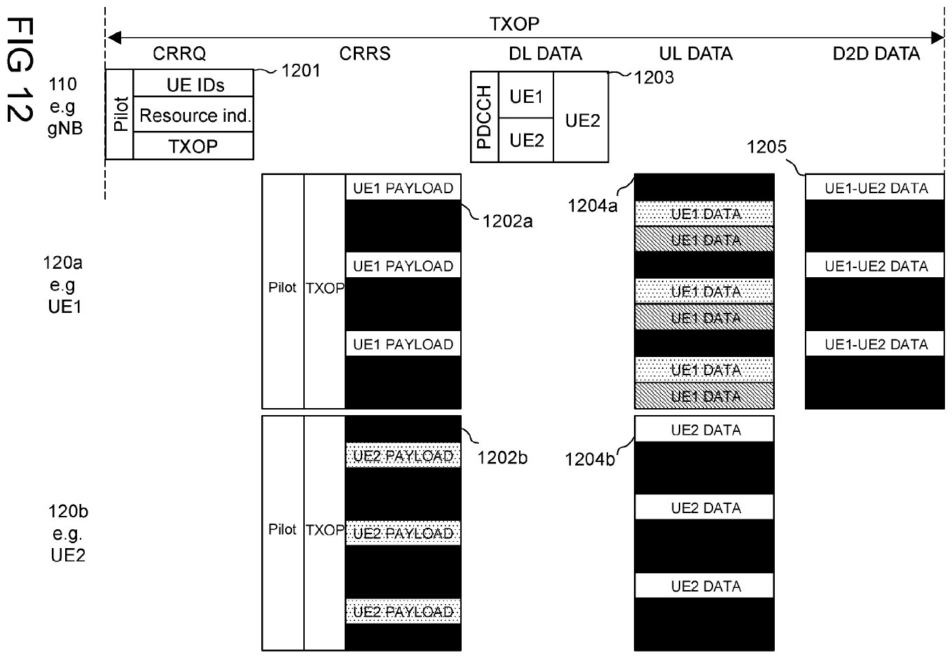

FIG. 11 is a flowchart schematically illustrating embodiments of a second method according to embodiments herein. The second method is implemented in, i.e. performed by, a wireless device, e.g. any one of the wireless devices 120a-c, e.g. a UE, such as any one of UE1-3 used in examples herein. The wireless device is in, e.g. served in or by, a wireless communication network, e.g. the wireless communication network 100. To simplify, the wireless device 120a will in the following be used to exemplify the wireless device that may perform one or more of the following actions. The second method may thus comprise the following actions, which actions may be taken in any suitable order and/or be carried out fully or partly overlapping in time when this is possible and suitable.

Action 1101

The wireless device 120a monitors, or checks, for a channel reservation request, e.g. CRRQ, message from a network node, e.g. the network node 110, of the wireless communication network 100.

The wireless device 120a may monitor a channel to detect CRRQ, for example monitoring the channel according to a configuration and/or in listening status or mode.

Action 1102

During the monitoring of Action 1102 a check may be made whether or not CRRQ is detected. If no CRRQ detection has been made, the method may return to action 1101.

The channel reservation request, or CRRQ, message preferably comprises:
Information, e.g. UE IDs or in general identifiers identifying wireless devices, based upon which at least two wireless devices, e.g. two or more of the wireless devices 120a-c, can be identified.
Information defining one or more transmission opportunities, e.g. TXOP, for said at least two wireless devices, which one or more transmission opportunities are reserved for transmitting responses, e.g. CRRS, to the channel reservation request, e.g. CRRQ, message to the network node 110.
the channel reservation request, e.g. CRRQ, message to the network node 110.

Action 1103

If the checking in Action 1102, results in that a CRRQ message is detected, then a check may be made whether a node ID of the wireless device 120a, e.g. UE ID the wireless device 120a, is included in the CRRQ message.

Action 1104

If the checking in Action 1103 finds that the node ID, e.g. UE ID, of the wireless device 120a, is included in the CRRQ message, then a CRRS may be sent in response, e.g. in an indicated resource according to the CRRQ message.

Hence, if a channel reservation request, or CRRQ, message containing an identification of the wireless device 120a is received, the wireless device 120a sends a response, e.g. CRRS, to the channel reservation request message to the network node 110.

Action 1105

If the checking in Action 1103 finds that the node ID of the wireless device 120a is not included in the CRRQ message, then the transmission may be deferred, e.g. until end of the one or more transmission opportunities, e.g. TXOP.

Action 1106

The wireless device 120a may receive, e.g. in response to or based on the sent CRRS, scheduling information from the network node 110, which scheduling information relates to at least one of:

a channel for transmitting data from the network node 110 to the wireless device 120a, i.e. scheduling information regarding the DL,

a channel for transmitting data from the wireless device 120a to the network node 110, i.e. scheduling information regarding the UL, and

a channel for transmitting data from a first wireless device to a second wireless device of the at least two wireless devices, e.g. from the wireless device 120a to the wireless device 120b, i.e. scheduling information regarding D2D.

FIG. 12 illustrates in some further detail examples of signaling involved in the methods and actions discussed above in relation to FIGS. 10 and 11. FIG. 12 exemplifies what may be sent from the network node 110, e.g. gnB, to wireless devices, such as discussed above in relation to FIG. 10, and in one TXOP. Numeral 1201 indicates transmission of CRRQ from the network node 110, e.g. with UE IDs of wireless devices 120a-b such as UE1 and UE2. This may fully or partly correspond to what may be transmitted according to Action 1001 discussed above. Numerals 1202a-b indicates transmission of CRRS from the wireless devices 120a-b, such as UE1 and UE2, respectively, in response to receipt of the CRRQ. This may fully or partly correspond to what may be transmitted according to Action 1104 discussed above. As indicated, the transmission may be based on interlacing. Numeral 1203 indicates transmission of data from the network node 110 to the wireless devices 120a-b, i.e. in the DL. This DL data transmission may be according to scheduling, e.g. following receipt of the CRRS. The scheduling may fully or partly correspond to scheduling as described for Action 1106 discussed above. Numerals 1204a-b indicate transmission of data from the wireless devices 120a-b, such as UE1 and UE2, respectively, i.e. in the UL, to the network node 110. This UL data transmission may be according to scheduling information received from the network node, e.g. fully or partly corresponding to receipt of scheduling information as described for Action 1106 discussed above. As indicated, also here interlacing may be utilized. Numeral 1205 indicates transmission of data between the wireless devices 120a-b, such as UE1 and UE2, respectively, i.e. Device to Device (D2D). This D2D transmission may also be according to scheduling information received from the network node, e.g. fully or partly corresponding to receipt of scheduling information as described for Action 1106 discussed above. As indicated, also here interlacing may be utilized.

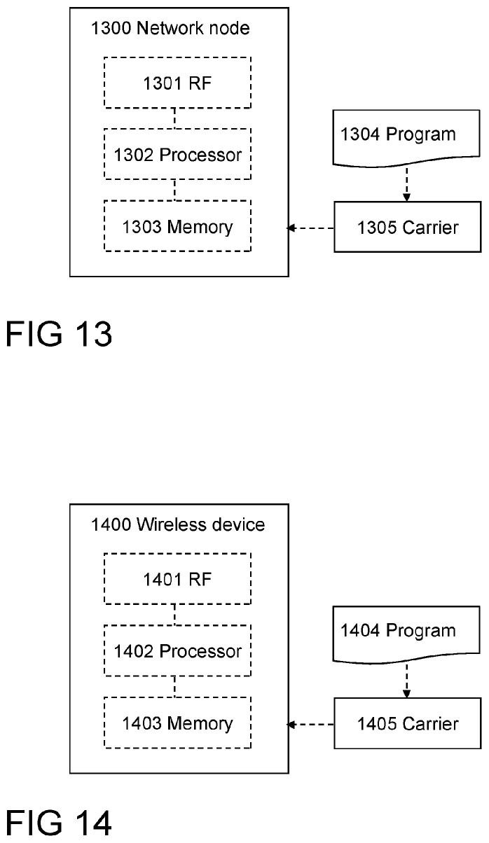

FIG. 13 schematically illustrates a node, more particularly a network node 1300, which may correspond to the network node 110 illustrated in FIG. 4. The network node 1300 comprises radio frequency, or RF, circuitry 1301, a processor 1302 and a memory 1303, the memory 1303 containing instructions executable by the processor 1302 whereby the network node 1300 is operative to perform embodiments of methods and actions described herein, such as the method and actions described above in connection with FIG. 10.

The instructions that are executable by the processor 1302 may be software in the form of a computer program 1304. The computer program 1304 may be contained in or by a carrier 1305, which may provide the computer program 1304 to the memory 1303 and processor 1302. The carrier 1305 may be in any suitable form including an electronic signal, an optical signal, a radio signal or a computer readable storage medium.

FIG. 14 schematically illustrates a wireless device, e.g. UE, 1400, which may correspond to any one of the wireless devices 120a-c illustrated in FIG. 4. The wireless device 1400 comprises radio frequency, or RF, circuitry 1401, a processor 1402 and a memory 1403, the memory 1403 containing instructions executable by the processor 1402 whereby the wireless device 1400 is operative to perform embodiments of methods and actions described herein, such as the method and actions described above in connection with FIG. 11.

The instructions that are executable by the processor 1402 may be software in the form of a computer program 1404. The computer program 1404 may be contained in or by a carrier 1405, which may provide the computer program 1404 to the memory 1403 and processor 1402. The carrier 1405 may be in any suitable form including an electronic signal, an optical signal, a radio signal or a computer readable storage medium.

Note that any processing module(s) and circuit(s) mentioned in the foregoing, e.g. RF circuitry, processors, memory etc., may be implemented as a software and/or hardware module, e.g. in existing hardware and/or as an Application Specific Integrated Circuit (ASIC), a field-programmable gate array (FPGA) or the like. Also note that any hardware module(s) and/or circuit(s) mentioned in the foregoing may e.g. be included in a single ASIC or FPGA, or be distributed among several separate hardware components, whether individually packaged or assembled into a System-on-a-Chip (SoC).

Those skilled in the art will also appreciate that the modules and circuitry discussed herein may refer to a combination of hardware modules, software modules, analogue and digital circuits, and/or one or more processors configured with software and/or firmware, e.g. stored in memory, that, when executed by the one or more processors may make the node(s) and device(s) to be configured to and/or to perform the above-described methods and actions.

Identification by any identifier herein may be implicit or explicit. The identification may be unique in a certain context, e.g. in the wireless communication network or at least in a relevant part or area thereof.

The term “network node” or simply “node” as used herein may as such refer to any type of node that may communicate with another node in and be comprised in a communication network. Further, such node may be or be comprised in a radio network node (described below) or any network node, which e.g. may communicate with a radio network node. Examples of such network nodes include any radio network node, a core network node, Operations & Maintenance (O&M), Operations Support Systems (OSS), Self Organizing Network (SON) node, etc.

The term “radio network node” as may be used herein may as such refer to any type of network node for serving a wireless communication device, e.g. a so-called User Equipment or UE, and/or that are connected to other network node(s) or network element(s) or any radio node from which a wireless communication device receives signals from. Examples of radio network nodes are Node B, Base Station (BS), Multi-Standard Radio (MSR) node such as MSR BS, eNB, eNodeB, gNB, network controller, RNC, Base Station Controller (BSC), relay, donor node controlling relay, Base Transceiver Station (BTS), Access Point (AP), New Radio (NR) node, transmission point, transmission node, node in distributed antenna system (DAS) etc.

Each of the terms “wireless communication device”, “user equipment” and “UE”, as may be used herein, may as such refer to any type of wireless device arranged to communicate with a radio network node in a wireless, cellular and/or mobile communication system, and may thus be referred to as a wireless device. Examples include: target devices, device to device UE, device for Machine Type of Communication (MTC), machine type UE or UE capable of machine to machine (M2M) communication, Personal Digital Assistant (PDA), iPAD, Tablet, mobile, terminals, smart phone, Laptop Embedded Equipment (LEE), Laptop Mounted Equipment (LME), Universal Serial Bus (USB) dongles etc.

While some terms are used frequently herein for convenience, or in the context of examples involving other a certain, e.g. 3GPP or other standard related, nomenclature, it must be appreciated that such term as such is non-limiting

Also note that although terminology used herein may be particularly associated with and/or exemplified by certain communication systems or networks, this should as such not be seen as limiting the scope of the embodiments herein to only such certain systems or networks etc.

As used herein, the term “memory” may refer to a data memory for storing digital information, typically a hard disk, a magnetic storage, medium, a portable computer diskette or disc, flash memory, random access memory (RAM) or the like. Furthermore, the memory may be an internal register memory of a processor.

Also note that any enumerating terminology such as first node, second node, first base station, second base station, etc., should as such be considered non-limiting and the terminology as such does not imply a certain hierarchical relation. Without any explicit information in the contrary, naming by enumeration should be considered merely a way of accomplishing different names.

As used herein, the expression “configured to” may mean that a processing circuit is configured to, or adapted to, by means of software or hardware configuration, perform one or more of the actions described herein.

As used herein, the terms “number” or “value” may refer to any kind of digit, such as binary, real, imaginary or rational number or the like. Moreover, “number” or “value” may be one or more characters, such as a letter or a string of letters. Also, “number” or “value” may be represented by a bit string.

As used herein, the expression “may” and “in some embodiments” has typically been used to indicate that the features described may be combined with any other embodiment disclosed herein.

As used herein, the expression “transmit” and “send” are typically interchangeable. These expressions may include transmission by broadcasting, uni-casting, group-casting and the like. In this context, a transmission by broadcasting may be received and decoded by any authorized device within range. In case of unicasting, one specifically addressed device may receive and encode the transmission. In case of group-casting, e.g. multicasting, a group of specifically addressed devices may receive and decode the transmission.

When using the word “comprise” or “comprising” it shall be interpreted as nonlimiting, i.e. meaning “consist at least of”.

The embodiments herein are not limited to the above described preferred embodiments. Various alternatives, modifications and equivalents may be used. Therefore, the above embodiments should not be taken as limiting the scope of the present disclosure, which is defined by the appending claims.

1. A method performed by a network node of a wireless communication network, the method comprising:
transmitting a channel reservation request message; and
monitoring for response to the channel reservation request message, the channel reservation request message comprising:
information based upon which at least two wireless devices can be identified, and
information defining one or more transmission opportunities for the at least two wireless devices, which said one or more transmission opportunities are reserved for transmitting responses to the channel reservation request message to the network node,
and wherein the monitoring for response to the channel reservation request message involves checking for said responses from the at least two wireless devices.

2. The method according to claim 1, wherein the method further comprises:
scheduling, for each of the at least two wireless devices from which said response has been received, at least one of:
a channel for transmitting data from the network node to the wireless device,
a channel for transmitting data from the wireless device to the network node, and
a channel for transmitting data from a first wireless device to a second wireless device of the at least two wireless devices.

3. The method according to claim 1, wherein the channel reservation request message further comprises:
a pilot, or
a channel state information reference signal, or
channel state information report requests for the at least two wireless devices.

4. (canceled)

5. (canceled)

6. The method according to claim 1, wherein the channel reservation request message further comprises a definition of a time frame within which said transmission opportunities are reserved for the at least two wireless devices.

7. The method according to claim 1, wherein the channel reservation request message further comprises information indicating transmission resources for the responses and that are reserved in a temporally overlapping manner.

8. The method according to claim 7, wherein the channel reservation request message comprises information specifying the temporally overlapping manner in which the transmission resources are reserved via instructions to the at least two wireless devices to transmit said responses in a multiplexed manner such that a first wireless device of the at least two wireless devices is assigned a first interlace for its response and a second wireless device of the at least two wireless devices is assigned a second interlace for its response.

9. The method according to claim 1, wherein the channel reservation request message further comprises information indicating transmission resources for the responses and that are reserved in a time-division-multiplexed manner such that a first wireless device of the at least two wireless devices is assigned a first transmission resource and a second wireless device of the at least two wireless devices is assigned a second transmission resource, which second transmission resource is subsequent to the first transmission resource.

10. A network node, configured to be a network node of a wireless communication network, comprising processing circuitry and a radio interface configured to: transmit a channel reservation request message from the network node, and monitor for response to the channel reservation request message, wherein the channel reservation request message comprises: information based upon which at least two wireless devices can be identified, and information defining one or more transmission opportunities for the at least two wireless devices, which one or more transmission opportunities are reserved for transmitting responses to the channel reservation request message to the network node, and wherein to monitor for response to the channel reservation request message involves checking for said responses from the at least two wireless devices.

11. The network node according to claim 10, wherein the processing circuitry is further configured to:
schedule, for each of the at least two wireless devices from which said response has been received, at least one of:
a channel for transmitting data from the network node to the wireless device,
a channel for transmitting data from the wireless device to the network node, and
a channel for transmitting data from a first wireless device to a second wireless device of the at least two wireless devices.

12. The network node according to claim 10, wherein the channel reservation request message further comprises:
a pilot, or
a channel state information reference signal, or
channel state information report requests for the at least two wireless devices.

13. (canceled)

14. (canceled)

15. The network node according to claim 10, wherein the channel reservation request message further comprises a definition of a time frame within which said transmission opportunities are reserved for the at least two wireless devices.

16. The network node according to claim 10, wherein the channel reservation request message further comprises information indicating transmission resources for the responses and that are reserved in a temporally overlapping manner.

17. The network node according to claim 16, wherein the channel reservation request message comprises information specifying the temporally overlapping manner in which the transmission resources are reserved via instructions to the at least two wireless devices to transmit said responses in a multiplexed manner such that a first wireless device of the at least two wireless devices is assigned a first interlace for its response and a second wireless device of the at least two wireless devices is assigned a second interlace for its response.

18. The network node according to claim 10, wherein the channel reservation request message further comprises information indicating transmission resources for the responses and that are reserved in a time-division-multiplexed manner such that a first wireless device of the at least two wireless devices is assigned a first transmission resource and a second wireless device of the at least two wireless devices is assigned a second transmission resource, which second transmission resource is subsequent to the first transmission resource.

19-21. (canceled)

22. A method performed by a wireless device in a wireless communication network, the method comprising:
monitoring for a channel reservation request message from a network node of the wireless communication network; and if a channel reservation request message containing an identification of the wireless device is received; and
sending a response to the channel reservation request message to the network node;
the channel reservation request message comprising information based upon which at least two wireless devices can be identified and information defining one or more transmission opportunities for the at least two wireless devices, which transmission opportunities are reserved for transmitting responses to the channel reservation request message to the network node.

23. The method according to claim 22, wherein the method further comprises:
receiving scheduling information from the network node, which scheduling information relates to at least one of:
a channel for transmitting data from the network node to the wireless device,
a channel for transmitting data from the wireless device to the network node, and
a channel for transmitting data from a first wireless device to a second wireless device of the at least two wireless devices.

24. The method according to claim 22, wherein the channel reservation request message further comprises:
a pilot, or
a channel state information reference signal, or
channel state information report requests for the at least two wireless devices, or
a definition of a time frame within which said transmission opportunities are reserved for the at least two wireless devices.

25-27. (canceled)

28. A wireless device for communication in a wireless communication network, the wireless device comprising a processing circuitry and a radio interface configured to: monitor for a channel reservation request message from a network node of the wireless communication network; and if a channel reservation request message containing an identification of the wireless device is received, send a response to the channel reservation request message to the network node,
wherein the channel reservation request message comprises information based upon which at least two wireless devices can be identified and information defining one or more transmission opportunities for the at least two wireless devices, which one or more transmission opportunities are reserved for transmitting responses to the channel reservation request message to the network node.

29. The wireless device as claimed in claim 28, wherein said processing circuitry and radio interface are further configured to receive scheduling information from the network node, which scheduling information relates to at least one of:
a channel for transmitting data from the network node to the wireless device,
a channel for transmitting data from the wireless device to the network node, and
a channel for transmitting data from a first wireless device to a second wireless device of the at least two wireless devices.

30. The wireless device according to claim 28, wherein the channel reservation request message further comprises:
a pilot, or
a channel state information reference signal, or
channel state information report requests for the at least two wireless devices, or
a definition of a time frame within which said transmission opportunities are reserved for the at least two wireless devices.

31-36. (canceled)
